(19) United States
(12) Patent Application Publication
(10) Pub. No.: US 2025/0153244 A1
(43) Pub. Date: May 15, 2025

(54) METAL POWDER ATOMIZATION MANUFACTURING PROCESSES

(71) Applicant: AP&C ADVANCED POWDERS & COATINGS INC., Boisbriand (CA)

(72) Inventors: Frédéric Larouche, Île Bizard (CA); Frédéric Marion, Montréal (CA); Matthieu Balmayer, Montréal (CA)

(21) Appl. No.: 19/022,552

(22) Filed: Jan. 15, 2025

Related U.S. Application Data
(63) Continuation of application No. 18/786,757, filed on Jul. 29, 2024.
Application No. 18/786,757 is a continuation of application No. 15/772,418, filed on Apr. 30, 2018, now abandoned.
(60) Provisional application No. 62/247,794, filed on Oct. 29, 2015.

(51) Int. Cl. B22F 9/08; B01J 2/02; B22F 1/052; B22F 1/14; B22F 1/16; B22F 9/04; B22F 9/14; C22C 1/04

(52) U.S. Cl. CPC B22F 9/082; B01J 2/02; B22F 1/052; B22F 1/14; B22F 1/16; B22F 9/04; B22F 9/14; B22F 2009/0824; B22F 2009/0828; B22F 2009/0848; B22F 2201/02; B22F 2201/03; B22F 2201/04; B22F 2201/50; B22F 2202/13; B22F 2998/10; B22F 2999/00; C22C 1/0408; C22C 1/0416; C22C 1/0458

(57) ABSTRACT

There are provided reactive metal powder atomization manufacturing processes. For example, such processes include providing a heated metal source and contact the heated metal source with at least one additive gas while carrying out the atomization process. Such processes provide raw reactive metal powder having improved flowability. The at least one additive gas can be mixed together with an atomization gas to obtain an atomization mixture, and the heated metal source can be contacted with the atomization mixture while carrying out the atomization process. Reactive metal powder spheroidization manufacturing processes are also provided.

### CROSS-REFERENCE TO RELATED APPLICATIONS

The present application claims priority to U.S. 62/247,794 filed on Oct. 29, 2015, which is hereby incorporated by reference in its entirety.

### FIELD OF THE DISCLOSURE

The present disclosure relates to the field of production of spheroidal powders such as reactive metal powders. More particularly, it relates to methods and apparatuses for preparing reactive metal powders by having improved flowability.

### BACKGROUND OF THE DISCLOSURE

Typically, the desired features of high quality reactive metal powders will be a combination of high sphericity, density, purity, flowability and low amount of gas entrapped porosities. Fine powders are useful for applications such as 3D printing, powder injection molding, hot isostatic pressing and coatings. Such fine powders are used in aerospace, biomedical and industrial fields of applications.

A powder having poor flowability may tend to form agglomerates having lower density and higher surface area. These agglomerates can be detrimental when used in applications that require of fine reactive metal powders. Furthermore, reactive powder with poor flowability can cause pipes clogging and/or stick on the walls of an atomization chamber of an atomizing apparatus or on the walls of conveying tubes. Moreover, powders in the form of agglomerates are more difficult to sieve when separating powder into different size distributions. Manipulation of powder in the form of agglomerates also increases the safety risks as higher surface area translates into higher reactivity.

By contrast, metal powders having improved flowability are desirable for various reasons. For example, they can be used more easily in powder metallurgy processes as additive manufacturing and coatings.

### SUMMARY

It would thus be highly desirable to be provided with a device, system or method that would at least partially address the poor flowability of reactive metal powder related to static electricity sensitivity. A high flowability powder usually translates in a higher apparent density and it can be spread more easily in order to produce an uniform layer of powder.

According to one aspect, there is provided a reactive metal powder atomization manufacturing process comprising:
providing a heated metal source; and
contacting said heated metal source with at least one additive gas while carrying out said atomization process.

According to another aspect, there is provided a reactive metal powder atomization manufacturing process comprising:
providing a heated metal source; and
contacting said heated metal source with at least one additive gas while carrying out said atomization process, thereby obtaining a raw reactive metal powder comprising particle size distribution of about 10 to about 53 μm having a flowability less than 40 s, measured according to ASTM B213;
particle size distribution of about 10 to about 45 μm having a flowability less than 40 s, measured according to ASTM B213;
particle size distribution of about 15 to about 45 μm having a flowability less than 40 s, measured according to ASTM B213;
particle size distribution of about 15 to about 53 μm having a flowability less than 40 s, measured according to ASTM B213;
particle size distribution of about 25 to about 45 μm having a flowability less than 40 s, measured according to ASTM B213;
particle size distribution of about 25 to about 53 μm having a flowability less than 40 s, measured according to ASTM B213;
particle size distribution of about 45 to about 75 μm having a flowability less than 28 s, measured according to ASTM B213;
particle size distribution of about 45 to about 106 μm having a flowability less than 28 s, measured according to ASTM B213;
particle size distribution of about 45 to about 150 μm having a flowability less than 28 s, measured according to ASTM B213; and/or
particle size distribution of about 45 to about 180 μm having a flowability less than 28 s, measured according to ASTM B213.

According to another aspect, there is provided a reactive metal powder atomization manufacturing process comprising:
providing a heated metal source;
mixing together an atomization gas and at least one additive gas to obtain an atomization mixture;
contacting said heated metal source with said atomization mixture while carrying out said atomization process.

According to another aspect, there is provided a reactive metal powder atomization manufacturing process comprising:
providing a heated metal source;
mixing together an atomization gas and at least one additive gas to obtain an atomization mixture;
contacting said heated metal source with said atomization mixture while carrying out said atomization process, thereby obtaining a raw reactive metal powder comprising
particle size distribution of about 10 to about 53 μm having a flowability less than 40 s, measured according to ASTM B213;
particle size distribution of about 10 to about 45 μm having a flowability less than 40 s, measured according to ASTM B213;
particle size distribution of about 15 to about 45 μm having a flowability less than 40 s, measured according to ASTM B213;
particle size distribution of about 15 to about 53 μm having a flowability less than 40 s, measured according to ASTM B213;
particle size distribution of about 25 to about 45 μm having a flowability less than 40 s, measured according to ASTM B213;
particle size distribution of about 25 to about 53 μm having a flowability less than 40 s, measured according to ASTM B213;
particle size distribution of about 45 to about 75 μm having a flowability less than 28 s, measured according to ASTM B213;
particle size distribution of about 45 to about 106 μm having a flowability less than 28 s, measured according to ASTM B213;
particle size distribution of about 45 to about 150 μm having a flowability less than 28 s, measured according to ASTM B213; and/or
particle size distribution of about 45 to about 180 μm having a flowability less than 28 s, measured according to ASTM B213.

According to another aspect, there is provided a metal powder atomization manufacturing process comprising:
providing a heated metal source; and
contacting said heated metal source with at least one additive gas while carrying out said atomization process under conditions sufficient to produce a reactive metal powder having an added content of each electronegative atom and/or molecule from the additive gas of less than 1000 ppm.

According to another aspect, there is provided a metal powder atomization manufacturing process comprising:
providing a heated metal source;
mixing together an atomization gas and at least one additive gas to obtain an atomization mixture; and
contacting said heated metal source with said atomization mixture while carrying out said atomization process under conditions sufficient to produce a raw reactive metal powder having an added content of electronegative atoms and/or molecules from the additive gas of less than 1000 ppm.

According to another aspect, there is provided a metal powder atomization manufacturing process comprising:
providing a heated metal source;
mixing together an atomization gas and at least one additive gas to obtain an atomization mixture;
contacting said heated metal source with said atomization mixture while carrying out said atomization process, thereby obtaining a raw metal powder;
sieving said raw reactive metal powder to obtain a powder having predetermined particle size; and
contacting said powder having said predetermined particle size with water.

According to another aspect, there is provided a reactive metal powder spheroidization manufacturing process comprising:
providing a reactive metal powder source; and
contacting said reactive metal powder source with at least one additive gas while carrying out said spheroidization process.

According to another aspect, there is provided a reactive metal powder spheroidization manufacturing process comprising:
providing a reactive metal powder source; and
contacting said reactive metal powder source with at least one additive gas while carrying out said spheroidization process, thereby obtaining a raw reactive metal powder comprising
particle size distribution of about 10 to about 53 μm having a flowability less than 40 s, measured according to ASTM B213;
particle size distribution of about 10 to about 45 μm having a flowability less than 40 s, measured according to ASTM B213;
particle size distribution of about 15 to about 45 μm having a flowability less than 40 s, measured according to ASTM B213;
particle size distribution of about 15 to about 53 μm having a flowability less than 40 s, measured according to ASTM B213;
particle size distribution of about 25 to about 45 μm having a flowability less than 40 s, measured according to ASTM B213;
particle size distribution of about 25 to about 53 μm having a flowability less than 40 s, measured according to ASTM B213;
particle size distribution of about 45 to about 75 μm having a flowability less than 28 s, measured according to ASTM B213;
particle size distribution of about 45 to about 106 μm having a flowability less than 28 s, measured according to ASTM B213;
particle size distribution of about 45 to about 150 μm having a flowability less than 28 s, measured according to ASTM B213; and/or
particle size distribution of about 45 to about 180 μm having a flowability less than 28 s, measured according to ASTM B213.

According to another aspect, there is provided a reactive metal powder spheroidization manufacturing process comprising:
providing a reactive metal powder source;
mixing together a spheroidization process gas and at least one additive gas to obtain a spheroidization process gas mixture;
contacting said reactive metal powder source with said spheroidization process gas mixture while carrying out said spheroidization process,
According to another aspect, there is provided a reactive metal powder spheroidization manufacturing process comprising:
providing a reactive metal powder source;
mixing together a spheroidization process gas and at least one additive gas to obtain a spheroidization process gas mixture;
contacting said reactive metal powder source with said spheroidization process gas mixture while carrying out said spheroidization process, thereby obtaining a raw reactive metal powder comprising
particle size distribution of about 10 to about 53 μm having a flowability less than 40 s, measured according to ASTM B213;
particle size distribution of about 10 to about 45 μm having a flowability less than 40 s, measured according to ASTM B213;
particle size distribution of about 15 to about 45 μm having a flowability less than 40 s, measured according to ASTM B213;
particle size distribution of about 15 to about 53 μm having a flowability less than 40 s, measured according to ASTM B213;
particle size distribution of about 25 to about 45 μm having a flowability less than 40 s, measured according to ASTM B213;
particle size distribution of about 25 to about 53 μm having a flowability less than 40 s, measured according to ASTM B213;
particle size distribution of about 45 to about 75 μm having a flowability less than 28 s, measured according to ASTM B213;
particle size distribution of about 45 to about 106 μm having a flowability less than 28 s, measured according to ASTM B213;
particle size distribution of about 45 to about 150 μm having a flowability less than 28 s, measured according to ASTM B213; and/or
particle size distribution of about 45 to about 180 μm having a flowability less than 28 s, measured according to ASTM B213.

According to another aspect, there is provided a reactive metal powder spheroidization manufacturing process comprising:
providing a reactive metal powder source; and
contacting said reactive metal source with at least one additive gas while carrying out said spheroidization process under conditions sufficient to produce a raw reactive metal powder having an added content of each electronegative atom and/or molecule from the additive gas of less than 1000 ppm.

According to another aspect, there is provided a reactive metal powder spheroidization manufacturing process comprising:
providing a reactive metal powder source;
mixing together a spheroidization process gas and at least one additive gas to obtain a spheroidization process gas mixture;
contacting said reactive metal powder source with said spheroidization process gas mixture while carrying out said spheroidization process under conditions sufficient to produce a raw reactive metal powder having an added content of electronegative atoms and/or molecules from the additive gas of less than 1000 ppm.

According to another aspect, there is provided a metal powder spheroidization manufacturing process comprising:
providing a reactive metal powder source;
mixing together spheroidization process gas and at least one additive gas to obtain a spheroidization process gas mixture;
contacting said reactive metal powder source with said spheroidization process gas mixture while carrying out said atomization process, thereby obtaining a raw metal powder;
sieving said raw reactive metal powder to obtain a powder having predetermined particle size;
contacting said powder having said predetermined particle size with water.

According to another example, there is provided a process for preparing a reactive metal powder mixture comprising mixing together a reactive metal powder obtained by a process as defined in the present disclosure, with a reactive metal powder obtained by a process different than those recited in the present disclosure.

According to another example, there is provided a process for preparing a reactive metal powder mixture comprising mixing together a reactive metal powder obtained by a process as defined in the present disclosure, with a reactive metal powder obtained by a process different than those recited in the present disclosure.

According to another example, there is provided a process for preparing a reactive metal powder mixture comprising mixing together a reactive metal powder obtained by a metal powder atomization manufacturing process as defined in the present disclosure, with a reactive metal powder obtained by a metal powder spheroidization manufacturing process as defined in the present disclosure.

According to another example, there is provided a reactive metal powder obtained by a process as defined in the present disclosure.

The present disclosure refers to methods, processes, systems and apparatuses that enable the production of reactive metal powder that exhibits a high flowability. The effect can be observed for various particle size distributions including for fine particle size distributions which would not even flow in a Hall flowmeter without the treatment described. One advantage of current method is that it does not add foreign particles in the powder. It is only a surface treatment that causes the improvement.

It was observed that the various technologies described in the present disclosure help to reduce the static electricity sensitivity of the powder which is resulting in improved flowability behavior of the powder.

### DRAWINGS

The following drawings represent non-limitative examples in which:

FIG. 1 is a cross-sectional view of an example atomizing system;

FIG. 2 is a schematic diagram of a particle of reactive metal powder formed according to an atomization process in which the heated metal source is not contacted with an additive gas;

FIG. 3 is a schematic diagram of a particle of reactive metal powder formed according to an atomization process in which the heated metal source is contacted with an additive gas

FIG. 4 illustrates a schematic diagram of a particle having a radius R and a plurality of particles each having a radius r formed from the same mass of material;

FIG. 5 illustrates a TOF-SIMS signature for a particle obtained from various testings;

FIG. 6 is a photograph of a batch of metal powder formed according to an atomization process that does not include the step of contacting with an additive gas; and

FIG. 7 is a photograph of a batch of metal powder formed according to an atomization process in which the metal source has been contacted with an additive gas.

### DESCRIPTION OF VARIOUS EMBODIMENTS

The following examples are presented in a non-limiting manner.

The word “a” or “an” when used in conjunction with the term “comprising” in the claims and/or the specification may mean “one”, but it is also consistent with the meaning of “one or more”, “at least one”, and “one or more than one” unless the content clearly dictates otherwise. Similarly, the word “another” may mean at least a second or more unless the content clearly dictates otherwise.

As used in this specification and claim(s), the words “comprising” (and any form of comprising, such as “comprise” and “comprises”), “having” (and any form of having, such as “have” and “has”), “including” (and any form of including, such as “include” and “includes”) or “containing” (and any form of containing, such as “contain” and “contains”), are inclusive or open-ended and do not exclude additional, unrecited elements or process steps.

The expression “atomization zone” as used herein, when referring to a method, apparatus or system for preparing a metal powder, refers to a zone in which the material is atomized into droplets of the material. The person skilled in the art would understand that the dimensions of the atomization zone will vary according to various parameters such as temperature of the atomizing means, velocity of the atomizing means, material in the atomizing means, power of the atomizing means, temperature of the material before entering in the atomization zone, nature of the material, dimensions of the material, electrical resistivity of the material, etc.

The expression “heat zone of an atomizer” as used herein refers to a zone where the powder is sufficiently hot to react with the electronegative atoms of the additive gas in order to generate a depletion layer, as discussed in the present disclosure.

The expression “metal powder has a X-Y μm particle size distribution means it has less than 5% wt. of particle above Y μm size with the latter value measured according to ASTM B214 standard. It also means it has less than 6% wt. of particle below X μm size (d6≥X μm) with the latter value measured according to ASTM B822 standard.

The expression “metal powder having a 15-45 μm particle size means it has less than 5% wt. of particle above 45 μm (measured according to ASTM B214 standard) and less than 6% wt. of particle below 15 μm (measured according to ASTM B822 standard).

The expression “Gas to Metal ratio” as used herein refers to the ratio of mass per unit of time (kg/s) of gas injected on the mass feedrate (kg/s) of the metal source provided in the atomization zone.

The expression “reactive metal powder” as used herein refers to a metal powder that cannot be efficiently prepared via the classical gas atomization process in which close-coupled nozzle is used. For example, such a reactive metal powder can be a powder comprising at least one member chosen from titanium, titanium alloys, zirconium, zirconium alloys, magnesium, magnesium alloys, aluminum and aluminum alloys.

The term “raw reactive metal powder” as used herein refers to a reactive metal powder obtained directly from an atomization process without any post processing steps such as sieving or classification techniques.

It was observed that reactive metal powder having fine particle sizes, such within a size distributions below 106 μm, possess more surface area and stronger surface interactions. These result in poorer flowability behavior than coarser powders. The flowability of a powder depends on one or more of various factors, such as particle shape, particle size distribution, surface smoothness, moisture level, satellite content and presence of static electricity. The flowability of a powder is thus a complex macroscopic characteristic resulting from the balance between adhesion and gravity forces on powder particles.

For example, particle size distribution can be:
of about 10 to about 53 μm having a flowability less than 40 s, measured according to ASTM B213;
of about 10 to about 45 μm having a flowability less than 40 s, measured according to ASTM B213;
of about 15 to about 45 μm having a flowability less than 40 s, measured according to ASTM B213;
of about 15 to about 53 μm having a flowability less than 40 s, measured according to ASTM B213;
of about 25 to about 45 μm having a flowability less than 40 s, measured according to ASTM B213;
of about 25 to about 53 μm having a flowability less than 40 s, measured according to ASTM B213;
of about 45 to about 75 μm having a flowability less than 28 s, measured according to ASTM B213;
of about 45 to about 106 μm having a flowability less than 28 s, measured according to ASTM B213;
of about 45 to about 150 μm having a flowability less than 28 s, measured according to ASTM B213; and/or of about 45 to about 180 μm having a flowability less than 28 s, measured according to ASTM B213.

For example, particle size distribution can be of about 10 to about 53 μm having a flowability less than 36 s, measured according to ASTM B213.

For example, particle size distribution can be of about 10 to about 53 μm having a flowability less than 32 s, measured according to ASTM B213.

For example, particle size distribution can be of about 10 to about 53 μm having a flowability less than 30 s, measured according to ASTM B213.

For example, particle size distribution can be of about 10 to about 53 μm having a flowability less than 28 s, measured according to ASTM B213.

For example, particle size distribution can be of about 10 to about 45 μm having a flowability less than 36 s, measured according to ASTM B213.

For example, particle size distribution can be of about 10 to about 45 μm having a flowability less than 32 s, measured according to ASTM B213.

For example, particle size distribution can be of about 10 to about 45 μm having a flowability less than 30 s, measured according to ASTM B213.

For example, particle size distribution can be of about 10 to about 45 μm having a flowability less than 28 s, measured according to ASTM B213.

For example, particle size distribution can be of about 15 to about 45 μm having a flowability less than 36 s, measured according to ASTM B213.

For example, particle size distribution can be of about 15 to about 45 μm having a flowability less than 32 s, measured according to ASTM B213.

For example, particle size distribution can be of about 15 to about 45 μm having a flowability less than 30 s, measured according to ASTM B213.

For example, particle size distribution can be of about 15 to about 45 μm having a flowability less than 28 s, measured according to ASTM B213.

For example, particle size distribution can be of about 15 to about 53 μm having a flowability less than 36 s, measured according to ASTM B213.

For example, particle size distribution can be of about 15 to about 53 μm having a flowability less than 32 s, measured according to ASTM B213.

For example, particle size distribution can be of about 15 to about 53 μm having a flowability less than 30 s, measured according to ASTM B213.

For example, particle size distribution can be of about 15 to about 53 μm having a flowability less than 28 s, measured according to ASTM B213.

For example, the raw reactive metal powder comprises a particle size distribution of about 25 to about 45 μm having a flowability less than 36 s, measured according to ASTM B213.

For example, the raw reactive metal powder comprises a raw reactive metal powder comprises a particle size distribution of about 25 to about 45 μm having a flowability less than 32 s, measured according to ASTM B213.

For example, the raw reactive metal powder comprises a raw reactive metal powder comprises a particle size distribution of about 25 to about 45 μm having a flowability less than 30 s, measured according to ASTM B213.

For example, the raw reactive metal powder comprises a particle size distribution of about 25 to about 45 μm having a flowability less than 25 s, measured according to ASTM B213.

For example, the raw reactive metal powder comprises a particle size distribution of about 25 to about 53 μm having a flowability less than 36 s, measured according to ASTM B213.

For example, the raw reactive metal powder comprises a particle size distribution of about 25 to about 53 μm having a flowability less than 32 s, measured according to ASTM B213.

For example, the raw reactive metal powder comprises a particle size distribution of about 25 to about 53 μm having a flowability less than 30 s, measured according to ASTM B213.

For example, the raw reactive metal powder comprises a particle size distribution of about 25 to about 53 μm having a flowability less than 25 s, measured according to ASTM B213.

For example, the raw reactive metal powder comprises a particle size distribution of about 45 to about 75 μm having a flowability less than 26 s, measured according to ASTM B213.

For example, the raw reactive metal powder comprises a particle size distribution of about 45 to about 75 μm having a flowability less than 25 s, measured according to ASTM B213.

For example, the raw reactive metal powder comprises a particle size distribution of about 45 to about 75 μm having a flowability less than 24 s, measured according to ASTM B213.

For example, the raw reactive metal powder comprises a particle size distribution of about 45 to about 75 μm having a flowability less than 23 s, measured according to ASTM B213.

For example, the raw reactive metal powder comprises a particle size distribution of about 45 to about 106 μm having a flowability less than 26 s, measured according to ASTM B213.

For example, the raw reactive metal powder comprises a particle size distribution of about 45 to about 106 μm having a flowability less than 25 s, measured according to ASTM B213.

For example, the raw reactive metal powder comprises a particle size distribution of about 45 to about 106 μm having a flowability less than 24 s, measured according to ASTM B213.

For example, the raw reactive metal powder comprises a particle size distribution of about 45 to about 106 μm having a flowability less than 23 s, measured according to ASTM B213.

For example, the raw reactive metal powder comprises a particle size distribution of about 45 to about 150 μm having a flowability less than 26 s, measured according to ASTM B213.

For example, the raw reactive metal powder comprises a particle size distribution of about 45 to about 150 μm having a flowability less than 25 s, measured according to ASTM B213.

For example, the raw reactive metal powder comprises a particle size distribution of about 45 to about 150 μm having a flowability less than 24 s, measured according to ASTM B213.

For example, the raw reactive metal powder comprises a particle size distribution of about 45 to about 150 μm having a flowability less than 23 s, measured according to ASTM B213.

For example, the raw reactive metal powder comprises a particle size distribution of about 45 to about 180 μm having a flowability less than 26 s, measured according to ASTM B213.

For example, the raw reactive metal powder comprises a particle size distribution of about 45 to about 180 μm having a flowability less than 25 s, measured according to ASTM B213.

For example, the raw reactive metal powder comprises a particle size distribution of about 45 to about 180 μm having a flowability less than 24 s, measured according to ASTM B213.

For example, the raw reactive metal powder comprises a particle size distribution of about 45 to about 180 μm having a flowability less than 23 s, measured according to ASTM B213.

For example, the heated metal source is contacted with said at least one additive gas in an atomizing zone of an atomizer.

For example, the heated metal source is contacted with said at least one additive gas within a heat zone of an atomizer.

For example, the heated metal source is contacted with said at least one additive gas at substantially the same time as contact with an atomizing gas.

For example, the atomizing gas is an inert gas.

For example, the atomizing gas and the additive gas are mixed together prior to contact with the heated metal source.

For example, the contacting with the additive gas causes formation of a first layer and a second layer on the surface of the raw metal particles, said first layer comprising atoms of said heated metal with atoms and/or molecules of said additive gas, said first layer being a depletion layer deeper and thicker than a native oxide layer, said second layer being a native oxide layer.

For example, the first layer has a substantially positive charge and the second layer has a substantially negative charge, and wherein the first layer and the second layer have a combined charge that is substantially neutral.

For example, the process further comprises:
sieving the raw reactive metal powder after atomizing of the heated metal source to separate the raw reactive metal powder by particle size distributions.

For example, the process further comprises:
after sieving, separately stirring the separated raw material powder in water.

For example, the water is distilled water or demineralized water.

For example, the flowability of the reactive metal powder is measured on the dried sieved metal powder after having been stirred.

For example, the reactive metal powder has an added content of each electronegative atom and/or molecule from the additive gas of less than 1000 ppm.

For example, the reactive metal powder has an added content of each of said electronegative atom and/or molecule from the additive gas of less than 500 ppm.

For example, the reactive metal powder has an added content of each of said electronegative atom and/or molecule from the additive gas of less than 250 ppm.

For example, the reactive metal powder has an added content of each of said electronegative atom and/or molecule from the additive gas of less than 200 ppm.

For example, the reactive metal powder has an added content of each of said electronegative atom and/or molecule from the additive gas of less than 150 ppm.

For example, the reactive metal powder has an added content of each of said electronegative atom and/or molecule from the additive gas of less than 100 ppm.

For example, the predetermined particle size is comprising any particle size distributions of about 10-53 μm such as 10-45 μm, 15-45 μm, 10-53 μm, 15-53 μm, and/or 25-45 μm.

For example, the at least one additive gas is an oxygen-containing gas.

For example, the at least one additive gas is an oxygen-containing gas chosen from O₂, CO₂, CO, NO₂, air, water vapor and mixtures thereof.

For example, the at least one additive gas is a halogen-containing gas.

For example, the halogen is F, Cl, Br or I.

For example, the at least one additive gas is a hydrogen-containing gas.

For example, the at least one additive gas is a sulfur-containing gas.

For example, the at least one additive gas is a nitrogen-containing gas.

For example, the at least one additive gas is chosen from O₂, H₂O, CO, CO₂, NO₂, N₂, NO₃, Cl₂, SO₂, SO₃, and mixtures thereof.

For example, the reactive metal powder comprises at least one of titanium, zirconium, magnesium, and aluminum.

For example, the reactive metal powder is a metal powder comprising at least one member chosen from one of titanium, titanium alloys, zirconium, zirconium alloys, magnesium, magnesium alloys, aluminum and aluminum alloys.

For example, the reactive metal powder comprises titanium.

For example, the reactive metal powder comprises a titanium alloy.

For example, the reactive metal powder comprises zirconium.

For example, the reactive metal powder comprises a zirconium alloy.

For example, the reactive metal powder is a metal powder comprising at least one member chosen from one of titanium and titanium alloys.

For example, the process is carried out by means of at least one plasma torch.

For example, the process is carried out by means of at least one plasma torch.

For example, the at least one plasma torch is a radio frequency (RF) plasma torch.

For example, the least one plasma torch is a direct current (DC) plasma torch.

For example, the least one plasma torch is a microwave (MW) plasma torch.

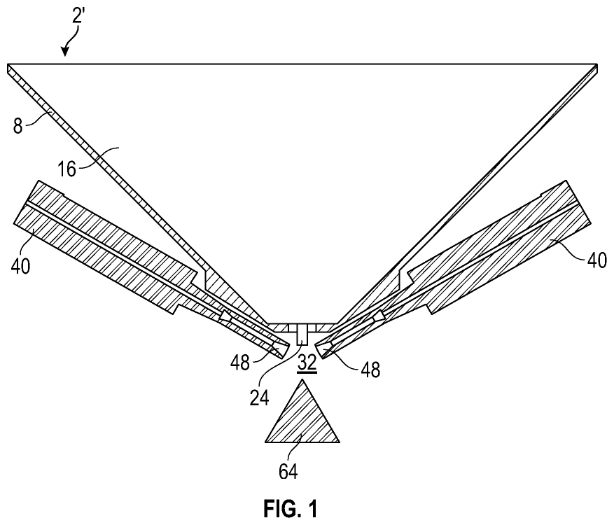

Referring now to FIG. 1, therein illustrated is a cross-section of an example of atomizing system 2′. The atomizing system 2′ includes a receptacle 8 that receives feed of a metal source 16 from an upstream system. For example, the feed of metal source 16 is provided as a melted stream, but it may be provided as a metal rod or wire as well. The metal source may be heated according to various techniques.

The heated metal source 16 is fed, through an outlet 24, into an atomization zone 32, which is immediately contacted with an atomizing fluid from an atomizing source 40. Contact of the heated metal source 16 by the atomizing fluid causes raw reactive metal powder 64 to be formed, which is then exited from the atomization zone 32. For example, the atomizing fluid may be an atomizing gas. For example, the atomizing gas may be an inert gas.

For example, the inert gas can be chosen from Ar and/or He.

It will be understood that while an atomizing system 2′ having atomizing plasma torches 40, methods and apparatus described herein for forming reactive metal powder having improved flowability may be applied to other types of spherical powder production system, such as skull melting gas atomization process, electrode induction melting gas atomization process (EIGA process), plasma rotating electrode process, plasma (RF, DC, MW) spheroidization process, etc.

According to the illustrated example, the plasma source 40 includes at least one plasma torch. At least one discrete nozzle 48 of the at least one plasma torch 40 is centered upon the metal source feed. For example, the cross-section of the nozzle 48 may be tapered towards the metal source feed so as to focus the plasma that contacts the metal source feed. As described elsewhere herein, the nozzle 48 may be positioned so that the apex of the plasma jet contacts the metal source fed from the receptacle 8. The contacting of the metal source feed by the plasma from the at least one plasma source 40 causes the metal source to be atomized.

Where a plurality of plasma torches are provided, the nozzles of the torches are discrete nozzles 48 of the plasma torches that are oriented towards the metal source from the receptacle 8. For example, the discrete nozzles 48 are positioned so that the apexes of the plasma jet outputted therefrom contacts the metal source from the receptacle 8.

According to various exemplary embodiments for preparing spheroidal powders, the heated metal source is contact with at least one additive gas while carrying out the atomization process.

The additive gas can be any gas comprising electronegative atom or molecule. The additive gas may include fluorine, chlorine, iodine, bromide, hydrogen-based, nitrogen-based and carbon-based compounds.

The additive gas may be an oxygen-containing gas. The expression “oxygen-containing gas” as used herein refers to a gas that contains at least one atom of oxygen. For example, such a gas may be O₂, CO₂, CO, NO₂, air, water vapor, ozone, etc.

According to various exemplary embodiments, the additive gas contacts the heated metal source 16 within the atomization zone 32 of an atomizer. This atomization zone 32 is a high heat zone of the atomizer. Accordingly, the heated metal source 16 may be contacted by the atomization gas and the additive gas at substantially the same time within the atomization zone 32.

The reaction between the metal particles produced from the atomization of the heated metal source and the additive gas can take place as long as the metal particles are sufficiently hot to allow the electronegative atoms and/or molecules to diffuse several tens of nanometers into the surface layer.

It will be understood that according to various exemplary embodiments described herein, the additive gas contacts the heated metal source during the atomization process in addition to the contacting of the heated metal source with the atomizing fluid.

It will be further understood that according to existing atomization processes, some additive gas may be inherently introduced into the atomizing fluid, such as through contamination, latent impurities, or leaks. For example, the introduced additive gas may include air or oxygen.

However, according to various exemplary embodiments described herein for producing spheroidal powders, the additive gas for contacting the heated metal source is deliberately provided in addition to any additive gas that could be inherently introduced during the atomization process.

According to various exemplary embodiments, a first set of nozzles projects the atomizing fluid into the atomization zone 32 to contact the heated metal source 16 and a second set of nozzles injects the additive gas into the atomization zone 32 to contact the heated metal source 16. Another alternative is that the second set of nozzles can mix the additive gas in a compatible fluid with the atomizing fluid prior to inject into the atomization zone 32. For example, the atomizing fluid and the additive gas contact the heated metal source 16 at substantially the same time or slightly after. For example, it is possible to mix the additive gas to dilute such additive gas and avoid too large local concentration that could result in an adverse or undesired reaction.

According to various alternative exemplary embodiments, the atomizing fluid is an atomizing gas, which is mixed with the at least one additive gas to form an atomization mixture. For example, the atomizing gas and the additive gas are mixed together prior to contact with the heated metal source. The atomizing gas and the additive gas may be mixed together within a gas storage tank or a pipe upstream of the contacting with the heated metal source. For example, the additive gas may be injected into a tank of atomizing gas. The injected additive gas is in addition to any additive gas inherently present into the atomizing gas.

The amount of additive gas contacting the heated metal source may be controlled based on desired end properties of the reactive metal powders to be formed from the atomization process.

For example, the additive gas contained within the formed reactive metal powder may be viewed as a contaminant of the metal powder. Accordingly, the amount of additive gas contacting the heated metal source is controlled so that the amount of atoms and/or molecules of the additive gas contained within the reactive metal powder is maintained within certain limits.

For example, the chemical composition limit within reactive metal powder may be prescribed by appropriate standards, such as the composition in table 1 of AMS 4998, ASTM F3001, ASTM F2924, ASTM B348, ASTM B350 and in table 3 of ASTM B550. Accordingly, the amount of additive gas contacting the heated metal source is controlled based on the composition of the additive gas and the limit or limits prescribed by standard for the one or more atoms and/or molecules composing the additive gas.

For example, where the additive gas contains oxygen and the reactive metal powder to be formed is titanium alloy powder, the amount of additive gas contacting the heated metal source is controlled so that the amount of oxygen within the formed reactive metal powder is below 1800 ppm according to the AMS 4998 standard and is below 1300 ppm according to ASTM F3001.

For example, where the additive gas contains carbon and the reactive metal powder to be formed is titanium alloy powder, the amount of additive gas contacting the heated metal source is controlled so that the amount of carbon within the formed reactive metal powder is below 1000 ppm according to the AMS 4998 standard and is below 800 ppm according to ASTM F3001.

For example, where the additive gas contains hydrogen and the reactive metal powder to be formed is titanium alloy powder, the amount of additive gas contacting the heated metal source is controlled so that the amount of hydrogen within the formed reactive metal powder is below 120 ppm according to the AMS 4998 standard and ASTM F3001.

For example, where the additive gas contains nitrogen and the reactive metal powder to be formed is titanium alloy powder, the amount of additive gas contacting the heated metal source is controlled so that the amount of nitrogen within the formed reactive metal powder is below about 400 ppm according to the AMS 4998 standard and is below 500 ppm according to ASTM F3001.

For example, where the additive gas contains chlorine and the reactive metal powder to be formed is titanium metal powder, the amount of additive gas contacting the heated metal source is controlled so that the amount of chlorine within the formed reactive metal powder is below about 1000 ppm according to the ASTM F3001 standard.

For example, the amount of additive gas contacting the heated metal source may be controlled by controlling the quantity of additive gas injected into the atomization gas when forming the atomization mixture. For example, the amount of additive gas injected may be controlled to achieve one or more desired ranges of ratios of atomization gas to additive gas within the formed atomization mixture.

For reactive metal powders formed without the addition of an additive gas, it was observed that reactive metal powders having various different particle size distributions and that had undergone sieving and blending steps did not always flow sufficiently to allow measurement of their flowability in a Hall flowmeter (see FIG. 1 of ASTM B213). For example, reactive metal powder falling within particle size distributions between 10-53 μm did not flow in a Hall flowmeter according to ASTM B213.

Without being bound by the theory, one important factor for causing the poor flowability of reactive metal powder is its sensitivity to static electricity. The sieving, blending and manipulation steps may cause particles of the reactive metal powder to collide with one another, thereby increasing the level of static electricity. This static electricity further creates cohesion forces between particles, which causes the reactive metal powder to flow poorly.

The raw reactive metal powder formed from atomizing the heated metal source by contacting the heated metal source with the atomization gas and the additive gas is further collected. The collected raw reactive metal powder contains a mixture of metal particles of various sizes. The raw reactive metal powder is further sieved so as to separate the raw reactive metal powder into different size distributions, such as 10-45 μm, 15-45 μm, 10-53 μm, 15-53 μm, and/or 25-45 μm.

After sieving, each particle size distribution of metal powder is separately stirred in distilled water or demineralized water. The stirring may help to remove electrostatic charges accumulated on the surface of the particles of the metal powder.

After sieving, each particle size distributions of metal powder is separately left to dry.

It was observed that reactive metal powders formed according to various exemplary atomization methods described herein in which the heated metal source is contacted with the additive gas exhibited substantially higher flowability than reactive metal powders formed from an atomization methods without the contact of the additive gas. This difference in flowability between metal powders formed according to the different methods can mostly be sized in metal powders having the size distributions of 10-45 μm, 15-45 μm, 10-53 μm, 15-53 μm and/or 25-45 μm or similar particle size distributions. However, it will be understood that metal powders in other size distributions may also exhibit slight increase in flowability when formed according to methods that include contact of the heated metal source with the additive gas.

It is well known that titanium forms a native surface oxide layer once exposed to air. This layer is typically about 3-5 nm and is composed essentially of titanium oxides (S. Axelsson, 2012, p. 37). The native oxide acts as a passivation layer and reduces the reactivity. This native layer has a strong affinity with water vapour (hydrophilic) and possesses hydroxyl group at the surface (Tanaka et al., 2008, p. 1; Lu et al., 2000, p. 1).

Without being bound by the theory, from contact of the heated metal source with the additive gas during atomization, atoms and/or molecules of the additive gas react with particles of the reactive metal powder as these particles are being formed. Accordingly, a first layer formed of a compound of the heated metal with the additive gas and that is depleting through the thickness is formed on the outer surface of the particles of the reactive metal particle. This layer is thicker and deeper in the surface and is located below the native oxide layer. For example, the compound of the heated metal with the additive gas in the depleted layer is metal oxide, nitride, carbide or halide. Since the atoms of the additive gas are depleting through the thickness of the surface layer, it forms a non stoichiometric compound with the metal. Such compound causes this first layer to have a substantially positive charge.

This first layer can only be formed at high temperature since the electronegative atoms and/or molecules need to have enough energy to diffuse much more into the surface layer than in a native oxide layer.

A second layer being a native oxide layer is further formed on the surface of the particles of the reactive metal powder. The hydroxyl group formed at the surface causes the second layer to have a substantially negative charge.

The first layer having a substantially positive charge and the second layer having a substantially negative charge form together an electric double layer. The combined charge of the double layer has a substantially neutral charge (i.e. net charge tending to zero). This neutral charge on the surface of the particles of the reactive metal powder may contribute to the improved flowability of the reactive metal powder formed according to exemplary methods and apparatuses described herein. For example, whereas a net charge on a particle, such as one formed according to traditional atomization methods, will favor polarization of the particle and increase the interaction with other particles, a weakly charged particle will have little electric interaction with other particles. This decreased interaction may lead to superior flowability.

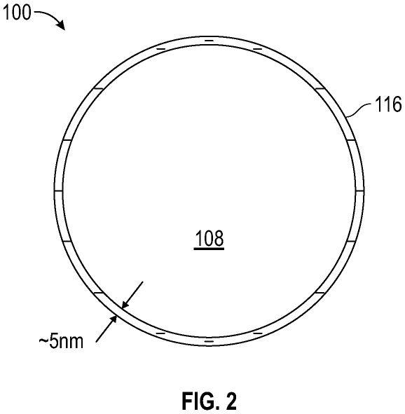

FIG. 2 illustrates a schematic diagram of a particle 100 of reactive metal powder formed according to an atomization processes in which the heated metal source 16 is not contacted with the additive gas. The formed particle 100 generally includes a particle body 108 (for example a Ti-6Al-4V particle) and a surface native oxide layer 116. The surface native oxide layer 116 has a generally negative charge, which gives the formed particle 100 a net non-zero charge (i.e for particle 108, Qₙₑₜ ≠0). Such negative charge gives a greater ability to polarize. The particle 108 also comprises hydroxyl groups at the surface 116.

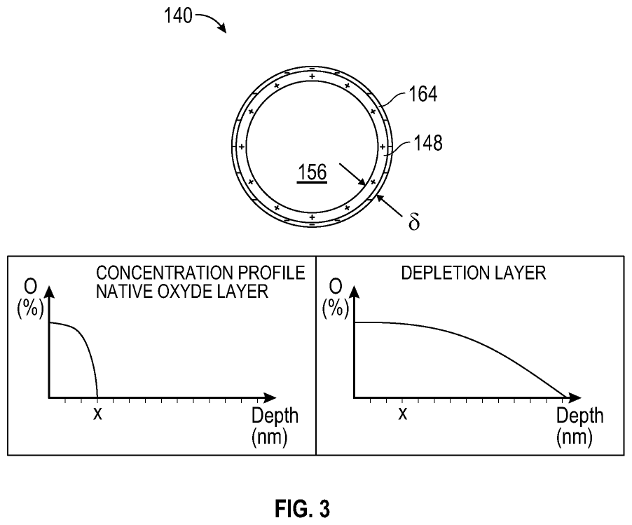

FIG. 3 illustrates a schematic diagram of a particle 140 of reactive metal powder formed according to exemplary atomization methods described herein in which the heated metal source 16 is contacted with an additive gas. A first layer 148 (or layer 1) is formed on the outer surface of the particle body 156 (for example a Ti-6Al-4V particle). It results from the compounding of the heated metal with the electronegative atoms and/or molecules that are depleting through the thickness. A second layer 164 (or layer 2) being a native oxide layer is further formed on the surface of the particle body 156. As described elsewhere herein, the first layer 148 and the second layer 164 have a combined charge that is substantially neutral, thereby causing the formed particle 140 to have a substantially net zero charge (Qₙₑₜ≈0) and a lower ability to polarize.

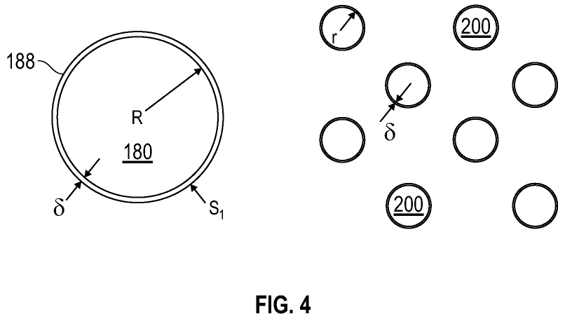

Following the theory that the electronegative atoms and/or molecules from the additive gas become a surface additive on the particles of the raw metal powder formed, the amount of additive gas injected with the atomization gas to form an atomization mixture may be controlled as it varies quasi linearly with the production rate of metal powder having a predetermined particle size distribution. The amount of additive gas needed to form the layer 1 is related to the total surface area of the metal particles which depends of the production rate and particle size distributions (see FIG. 4). The concentration of the additive gas and the thermal conditions of the metal particles will determine the depleting layer depth of the layer 1.

Further following the theory that the electronegative atoms and/or molecules from the additive gas become a surface additive on particles of the raw metal powder formed, the amount of additive gas injected with the atomization gas to form an atomization mixture may be controlled as it varies with the total area of the particles of the metal powder formed as shown in FIG. 4.

Further following the theory that the electronegative atoms and/or molecules from the additive gas become a surface additive on particles of the raw metal powder formed, the amount of additive gas injected with the atomization gas to form an atomization mixture may be controlled as it varies with the temperature of the surface of the particles of the raw metal powder formed. The reaction rate (D of such chemical reaction of activation energy E generally follows an Arhenius relation with the temperature T:

$$Φ ∝ {e}^{- \frac{E}{kT}}$$

The injection of the additive gas at high temperature is thus more efficient and requires less additive gas concentration to generate the ideal depletion depth and form the layer 1.

FIG. 4 illustrates a schematic diagram of a particle 180 having a radius R and a depletion depth of δ at the surface of the particle 188. The total surface area of the particle is S₁=4πR².

FIG. 4 further illustrates a schematic diagram of a plurality of particles (n particles) 200 of the same size having the same total mass as the mass of the particle 180. The particles 200 are smaller in size than particle 180 but they have a larger surface area in total than particle 180. each particle 200 having a radius r and the total number of particles being n=R³/r³. The combined surface area of the particles 200 is

$${S}_{2} = n 4 π {r}^{2} = \frac{R}{r} {S}_{1} .$$

It increases linearly with decreasing radius of particles.

The amount of surface additive added is thus a function of the total surface area as the volume that will be treated is the product of the total surface area by the depletion depth.

For example, the obtained metal powders can have less than about 100, 150, 200, 300, 500, 1000 or 1500 ppm of an electronegative atom and/or molecule (for example an electronegative atom and/or molecule element that is comprised within the additive gas used to produce the powder).

### Experiment 1

Four different lots of powder were produced by plasma atomization under the same experimental conditions except for the composition of the atomization mixture contacting the heated metal source.

The atomizing gas is high purity argon (>99.997%).

In Tests 1 and 2, only the atomizing gas was used to contact the heated metal source during the atomization process.

In Test 3, air was injected to the high purity argon to form an atomization mixture of 80 ppm of air with argon. Heated metal was contacted with the atomization mixture during the atomization process.

In Test 4, O₂ was injected to the high purity argon to form an atomization mixture of 50 ppm of O₂ with argon. Heated metal was contacted with this second atomization mixture during the atomization process.

After contacting with the atomizing gas (Test 1 and 2) or the atomization mixture (Test 3 and 4), formed raw reactive metal powder is sieved to isolate the 15-45 μm particle size distributions.

The sieved powder is then mixed to ensure homogeneity.

The powder was further stirred in distilled water or demineralized water to remove static electricity charges accumulated during previous steps.

The powder was dried in air at 80° C. for 12 h.

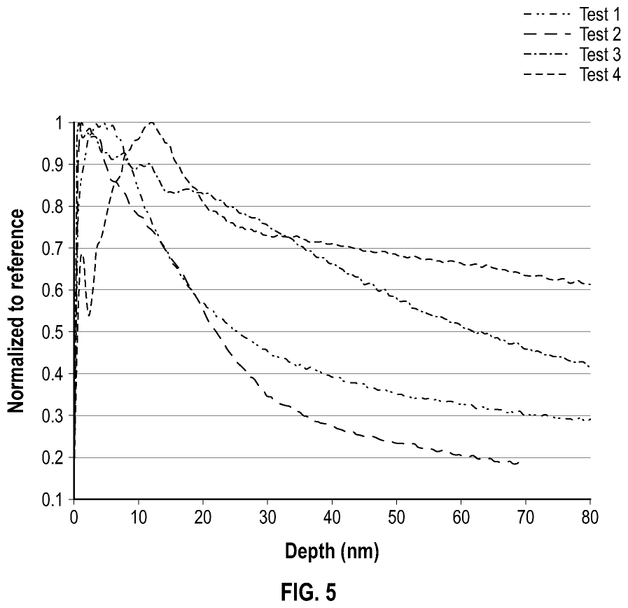

FIG. 5 is a graph illustrating the oxygen profile comparison between different samples by TOF-SIMS. The TOF-SIMS signature of powder is obtained for Test 1 to 4. The presence of a depletion layer can be associated with the high flowability powders as can be seen in Table 1.

The TOF-SIMS signature of a fine powder that has been treated can be clearly seen from the FIG. 5. A tail in the oxygen content enters deeper in the surface layer. It is critical to obtain this depletion layer with a certain critical depth in order to get the improved flowability behavior. The TOF-SIMS results suggest that the depletion layer has a depth of the order of 100 nm. The depth can be estimated by calibrating the sputtering rate of the ion beam obtained on a Ti-6Al-4V bulk part with a profilometer. The sputtering rate depends of the ion beam intensity and of the type of material. The calibration is done prior to measurements and the ion beam energy is very stable.

TABLE 1
Test 1 to 4 description with flowability and apparent density
measured on a 15-45 μm particle size distribution

| | | | | Visual compaction |
|---|---|---|---|---|
| | Additive gas | | Apparent | in the collection |
| | Concentration | Flowability | density | bucket after |
| Lot # | (ppm) | (s) | (g/cm³) | atomization |
| Test 1 | 0 | NF | NA | bad |
| Test 2 | 0 | NF | NA | bad |
| Test 3 | 80 ppm air | 27.3 | 2.51 | good |
| Test 4 | 50 ppm O2 | 27 | 2.50 | good |
| | | Per ASTM | Per ASTM | |
| | | B213 | B212 | |

TABLE 2
Powder chemical composition of Test 1 to 4 on a 15-45 μm particle size distribution
Chemical Composition (wt. %)

| Lot # | O | N | H | C | Fe | Al | V | Ti |
|---|---|---|---|---|---|---|---|---|
| Test 1 | 0.102 | 0.007 | 0.0043 | 0.008 | 0.13 | 6.35 | 3.94 | 88.94 |
| Test 2 | 0.094 | 0.01 | 0.0022 | 0.016 | 0.21 | 6.37 | 3.91 | 88.85 |
| Test 3 | 0.084 | 0.025 | 0.0016 | 0.01 | 0.21 | 6.39 | 3.87 | 88.87 |
| Test 4 | 0.112 | 0.005 | 0.0084 | 0.011 | 0.13 | 6.33 | 3.82 | 89.03 |

| | | | |
|---|---|---|---|
| Per ASTM E1409 | Per ASTM E1447 | Per ASTM E1941 | Per ASTM E2371 |

TABLE 3
Particle size distributions of Test 1 to 4
on a 15-45 μm particle size distribution
Particle size distribution (wt. %)

| Lot # | >53 | >45 | ≤45 >25 | <25 | Total | D10 | D50 | D90 |
|---|---|---|---|---|---|---|---|---|
| Test 1 | 0 | 2.2 | 80.6 | 17.2 | 100 | 20.9 | 33.0 | 43.6 |
| Test 2 | 0.5 | 1.5 | 72.2 | 25.8 | 100 | 21.4 | 33.3 | 44.7 |
| Test 3 | 0.1 | 2.2 | 71.9 | 25.8 | 100 | 22.5 | 33.7 | 44.3 |
| Test 4 | 0 | 3.0 | 69.0 | 28.0 | 100.0 | 22.6 | 34.1 | 45.5 |

| | |
|---|---|
| Per ASTM B214 | Per ASTM B822 |

It was determined from statistical data analysis of many batches that the injection of air (Test 3) adds about 100-150 ppm of nitrogen and about 50 ppm of oxygen to the powder. The injection of air improved flowability of the formed reactive metal powder.

It was further determined from statistical data analysis that injection of only O₂ (Test 4) adds about 150-200 ppm of oxygen and no nitrogen.

Additional successful tests on the flowability of 15-45 μm particle size distribution have been carried by injecting water vapor. Improvement of flowability of 15-45 μm particle size distribution was also observed.

The treatment performed maintains a satisfying chemical composition according to the composition of standard ASTM B348, ASTM F2924 and ASTM F3001. It would have also complied with those of AMS 4998 if the oxygen of the raw material would have been slightly higher.

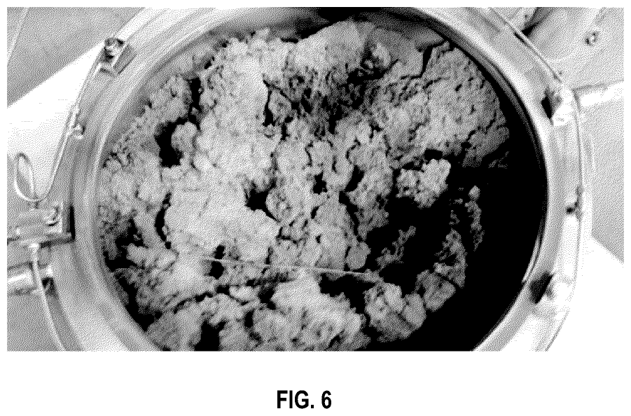

FIG. 6 is a photograph of a batch of about 100 kg of metal powder formed according to an atomization process that does not include contacting with the additive gas. Due to agglomerates, 90% of the collecting bucket is filled and the visual compaction is bad.

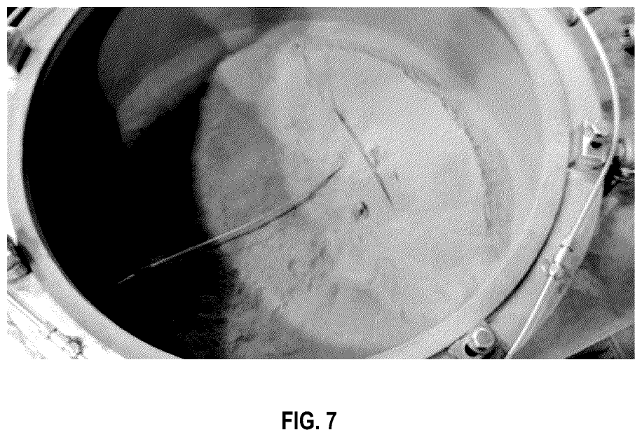

FIG. 7 is a photograph of a batch of about 100 kg of metal powder formed according to an atomization process in which the metal source is contacted with the additive gas. Due to improved flowability and lower surface interactions between particles, 20% of the collecting bucket is filled for the same amount of material as used during the run of FIG. 6 and the visual compaction is good.

Tests similar to Test 3 and 4 have been carried by intermittently injecting the additive gas. It was found that the treatment was still effective while having the advantage of adding less impurity to the final product.

Similarly, we showed that a mixture of up to 30% of powder with good flowability can be blended with 70% of powder that did not flow in Hall flowmeter and the resulting powder was still flowing even if not as well as the starting powder.

### Experiment 2

Heat treatment was performed a posteriori on already-formed metal powder that was formed from a process in which additive gas was not used.

More specifically, the already-formed metal powder was heated in air atmosphere at about 250° C. for 12 hours. It was expected that this heating would cause addition of oxygen to surface of particles of the raw metal powder and increase the thickness of the native oxide layer.

It was observed that oxidation/nitridation a posteriori did not produce a similar result to that of contacting the additive gas in the atomization zone of an atomization process. The improvement of the flowability of the metal powder was not observed.

It seems that a posteriori heating of already-formed metal powder will only thicker the native oxide layer and did not have the ability to provide a sufficient deep and depletion oxide/nitride layer on the particle. The thicker oxide layer will also remain quasi stochiometric and will not be able to provide the positively charged layer 1 which is provided by the depletion layer.

Without being bound to the theory, the high temperature involved during the atomization and the low concentration of additive gas enable the oxidation/nitridation reaction that forms the depletion oxide/nitride layer when the metal source is contacted with the additive gas.

Embodiments of paragraphs [0027] to [00192] of the present disclosure are presented in such a manner in the present disclosure so as to demonstrate that every combination of embodiments, when applicable can be made. These embodiments have thus been presented in the description in a manner equivalent to making dependent claims for all the embodiments that depend upon any of the preceding claims (covering the previously presented embodiments), thereby demonstrating that they can be combined together in all possible manners. For example, all the possible combination, when applicable, between the embodiments of paragraphs [0027] to [00192] and the processes of paragraphs [0006] to [0026] are hereby covered by the present disclosure.

It will be appreciated that, for simplicity and clarity of illustration, where considered appropriate, reference numerals may be repeated among the figures to indicate corresponding or analogous elements or steps. In addition, numerous specific details are set forth in order to provide a thorough understanding of the exemplary embodiments described herein. However, it will be understood by those of ordinary skill in the art that the embodiments described herein may be practiced without these specific details. In other instances, well-known methods, procedures and components have not been described in detail so as not to obscure the embodiments described herein. Furthermore, this description is not to be considered as limiting the scope of the embodiments described herein in any way but rather as merely describing the implementation of the various embodiments described herein.

1-188. (canceled)

189. A reactive metal powder atomization manufacturing process comprising:
atomizing with an atomizing gas a heated reactive titanium alloy source to produce a raw reactive metal powder of titanium alloy particles, wherein atomizing the heated reactive titanium alloy source comprises intermittently injecting an additive gas to impart a component from the additive gas on particles of the raw reactive metal powder, the raw reactive metal powder comprising a powder having a particle size distribution of 10 to 53 micrometers with a flowability less than 40 s, measured according to ASTM B213.

190. The reactive metal powder atomization manufacturing process of claim 189, wherein intermittently injecting the additive gas to impart a component from the additive gas on particles of the raw reactive metal powder comprises mixing the additive gas with a non-additive gas.

191. The reactive metal powder atomization manufacturing process of claim 190, wherein the non-additive gas is the atomizing gas.

192. The reactive metal powder atomization manufacturing process of claim 190, wherein the non-additive gas is a sheath gas.

193. The reactive metal powder atomization manufacturing process of claim 189, wherein intermittently injecting the additive gas to impart a component from the additive gas on particles of the raw reactive metal powder comprises maintaining a concentration of the additive gas at a concentration of 80 parts per million (ppm) or less within an atomization zone.

194. The reactive metal powder atomization manufacturing process of claim 193, wherein maintaining the concentration of the additive gas further comprises maintaining the concentration of the additive gas at a concentration of 50 ppm or more within the atomization zone.

195. The reactive metal powder atomization manufacturing process of claim 189, further comprising:
exposing the raw reactive metal powder to the intermittently injected additive gas within an atomization zone to impart a component from the additive gas on particles of the raw reactive metal powder and maintain a chemical composition of the raw reactive metal powder, the raw reactive metal powder having a flowability less than 40 s, measured according to ASTM B213.

196. The reactive metal powder atomization manufacturing process of claim 195, wherein the additive gas comprises an oxygen-containing gas, and wherein maintaining the chemical composition of the raw reactive metal powder comprises maintaining the oxygen within the raw reactive metal powder below 1800 ppm according to AMS 4998.

197. The reactive metal powder atomization manufacturing process of claim 196, wherein the particles are Ti-6Al-4V particles.

198. The reactive metal powder atomization manufacturing process of claim 196, wherein the particles are Ti-6Al-4V particles, wherein the additive gas contains nitrogen, and wherein maintaining the chemical composition of the raw reactive metal powder comprises maintaining the nitrogen within the raw reactive metal powder below 400 ppm according to AMS 4998.

199. The reactive metal powder atomization manufacturing process of claim 196, wherein the particles are Ti-6Al-4V particles, wherein the additive gas contains carbon, and wherein maintaining the chemical composition of the raw reactive metal powder comprises maintaining the carbon within the raw reactive metal powder below 1000 ppm according to AMS 4998.

200. The reactive metal powder atomization manufacturing process of claim 196, wherein the particles are Ti-6Al-4V particles, wherein the additive gas contains hydrogen, and wherein maintaining the chemical composition of the raw reactive metal powder comprises maintaining the hydrogen within the raw reactive metal powder below 120 ppm according to AMS 4998.

201. The reactive metal powder atomization manufacturing process of claim 196, wherein the particles are Ti-6Al-4V particles, wherein the additive gas contains chlorine, and wherein maintaining the chemical composition of the raw reactive metal powder comprises maintaining the chlorine within the raw reactive metal powder below 1000 ppm according to AMS 4998.

202. The reactive metal powder atomization manufacturing process of claim 189, wherein the raw reactive metal powder comprises a powder having a particle size distribution of 25 to 45 μm having a flowability less than 40 s, measured according to ASTM B213.

203. The reactive metal powder atomization manufacturing process of claim 189, wherein the raw reactive metal powder has a flowability less than 30 s, measured according to ASTM B213.

204. The reactive metal powder atomization manufacturing process of claim 189, wherein the raw reactive metal powder has a flowability less than 28 s, measured according to ASTM B213.

205. The reactive metal powder atomization manufacturing process of claim 189, wherein the atomizing gas is provided from at least one plasma source.
